(19) United States
(12) Patent Application Publication
(10) Pub. No.: US 2014/0019347 A1
(43) Pub. Date: Jan. 16, 2014

(54) SOCIAL CONNECTIVITY SYSTEM AND METHOD

(71) Applicant: Frank DiMaggio, Tempe, AZ (US)

(72) Inventor: Frank DiMaggio, Tempe, AZ (US)

(21) Appl. No.: 13/546,977

(22) Filed: Jul. 11, 2012

(51) Int. Cl. G06F 15/16; G06Q 20/14

(52) U.S. Cl. 705/40; 709/204

(57) ABSTRACT

A method and system for community-based social connectivity. In one implementation, the method can include establishing a group from a plurality of members of a predetermined organization, and storing in memory personal information about the members. In some embodiments, the method can include adding members to the group, and associating at least some members with at least one subgroup at least partially based on the personal information. The method can provide associating the members with a personal communication board and a community communication board and receiving communications from one or more members. The method can include displaying communications created by the members on the personal communication and community communication boards. In some embodiments, the method can include automatically generating and displaying an advertising message on the personal communication and community communication boards so that the advertising message comprises a substantially similar appearance to the communications created the members.

### BACKGROUND

At least some conventional social connectivity systems and social networks can enable social interactions between multiple persons or groups. Membership in at least some of these conventional systems and networks is often not based on any significant criteria so that any individual who wishes to join is able to become a part of the conventional system or network. Although these permissive membership criteria can enable social interactions between persons or groups, it can at least partially inhibit or retard the development of social interactions between members of some currently-existing groups.

### SUMMARY

Some embodiments of the invention provide a method for social connectivity. In some embodiments, the method can include establishing a group from a plurality of members of a predetermined organization, and storing in memory personal information about the member. In some embodiments, the method can include adding the plurality of members to the group, and associating at least some of the plurality of members with at least one subgroup at least partially based on the personal information. The method can include associating the plurality of members with a personal communication board and a community communication board and receiving a plurality of communications created by at least a portion of the members. The method can also include displaying at least some of the plurality of communications created by the members on at least one of the personal communication board and the community communication board. In some embodiments, the method can include generating and displaying at least one advertising message on at least one of the personal communication board and the community communication board so that the advertising message can comprise a substantially similar appearance to the plurality of communications created by at least a portion of the members.

### DESCRIPTION OF THE DRAWINGS

FIG. 1 is an image of an access page according to one embodiment of the invention.

FIG. 2 is an image of an image upload page according to one embodiment of the invention.

FIG. 3 is an image of a community signup page according to one embodiment of the invention.

FIG. 4 is an image of a merchant signup page according to one embodiment of the invention.

FIG. 5A is an image of a portion of an administrator home page according to one embodiment of the invention.

FIG. 5B is an image of a portion of an administrator home page according to one embodiment of the invention.

FIG. 5C is an image of a members page according to one embodiment of the invention.

FIG. 6 is an image of a maintenance request page according to one embodiment of the invention.

FIG. 7A is an image of a portion of a message center page according to one embodiment of the invention.

FIG. 7B is an image of a portion of a message center page according to one embodiment of the invention.

FIG. 7C is an image of a portion of a message center page according to one embodiment of the invention.

FIG. 8 is an image of a members search page according to one embodiment of the invention.

FIG. 9 is an image of a home page and a chat dialogue box according to one embodiment of the invention.

FIG. 10A is an image of a portion of a community page according to one embodiment of the invention.

FIG. 10B is an image of a portion of a community page according to one embodiment of the invention.

FIG. 11A is an image of a portion of a personal home page according to one embodiment of the invention.

FIG. 11B is an image of a portion of a personal home page according to one embodiment of the invention.

FIG. 12 is an image of an access page according to one embodiment of the invention.

FIG. 13 is an image of a home page according to one embodiment of the invention.

FIG. 14A is an image of a personal communication board according to one embodiment of the invention.

FIG. 14B is an image of a community communication board according to one embodiment of the invention.

FIG. 15A is an image of a friends page according to one embodiment of the invention.

FIG. 15B is an image of a related interests page according to one embodiment of the invention.

FIG. 16A is an image of a chat dialogue box according to one embodiment of the invention.

FIG. 16B is an image of a chat group member listing according to one embodiment of the invention.

FIG. 17A is an image of a merchant roster according to one embodiment of the invention.

FIG. 17B is an image of a daily sales offering according to one embodiment of the invention.

FIG. 18 is an image of a community events calendar according to one embodiment of the invention.

FIG. 19 is a series of images illustrating submission of a maintenance request using a maintenance request page according to one embodiment of the invention.

FIG. 20A is an image of a package pickup page according to one embodiment of the invention.

FIG. 20B is an image of a package status page according to one embodiment of the invention

FIG. 21 is an image of a message center page according to one embodiment of the invention.

FIG. 22 is an image of a members page according to one embodiment of the invention.

FIG. 23 is a series of images of a maintenance request page according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention provide a social networking application to allow users to one or more groups, networks, and/or any other suitable interactive process or application that enables social interconnectivity. In some embodiments, the social networking application can include computer program code that is executable by a processor of a computer (e.g., personal computer, laptop, gaming machine, smart phone, etc.) and/or a processing unit of a server and can be accessed by a user (e.g., an administrator) via the computer. The computer can be in communication with the server via a network to receive and transmit information through a web-based program controlled by the application. This information, such as user information, property information, and other program information, as further described below, can be stored on a computer-readable medium of the computer (e.g., a computer storage unit) and/or on a computer-readable medium of the server (e.g., a server database). In some embodiments, the entire application or a portion of the application can be stored on the computer. In other embodiments, the entire application or a portion of the application can be stored on the server and can be accessed by the computer when the server and the computer are connected via the common network.

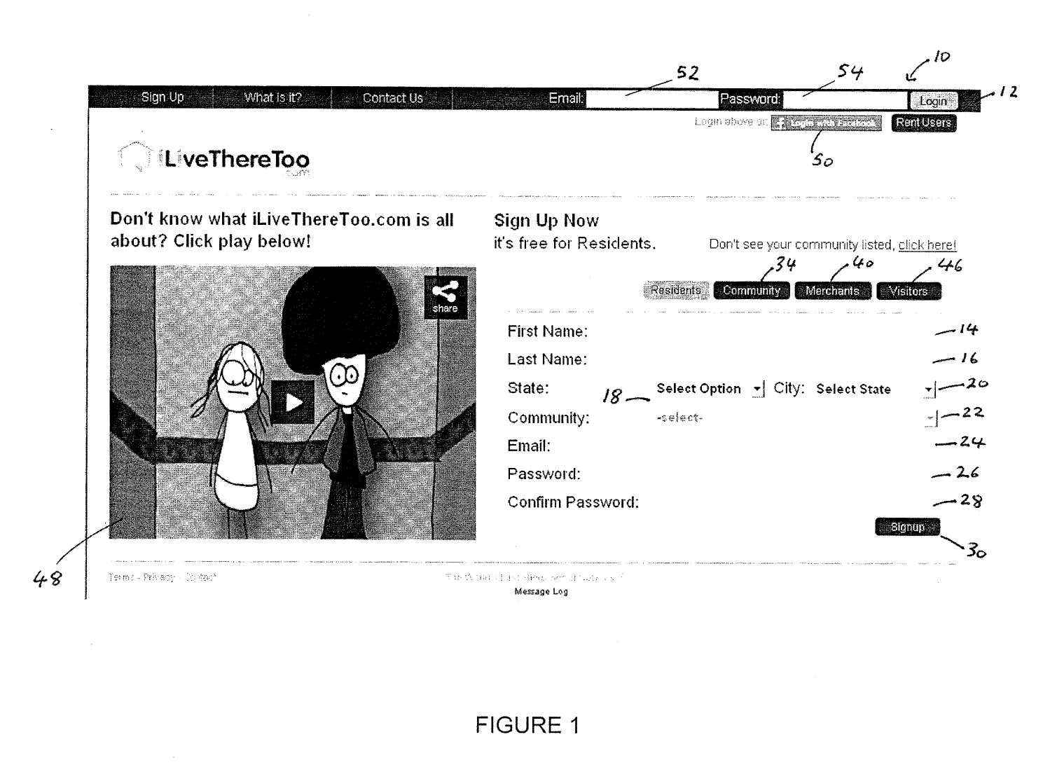

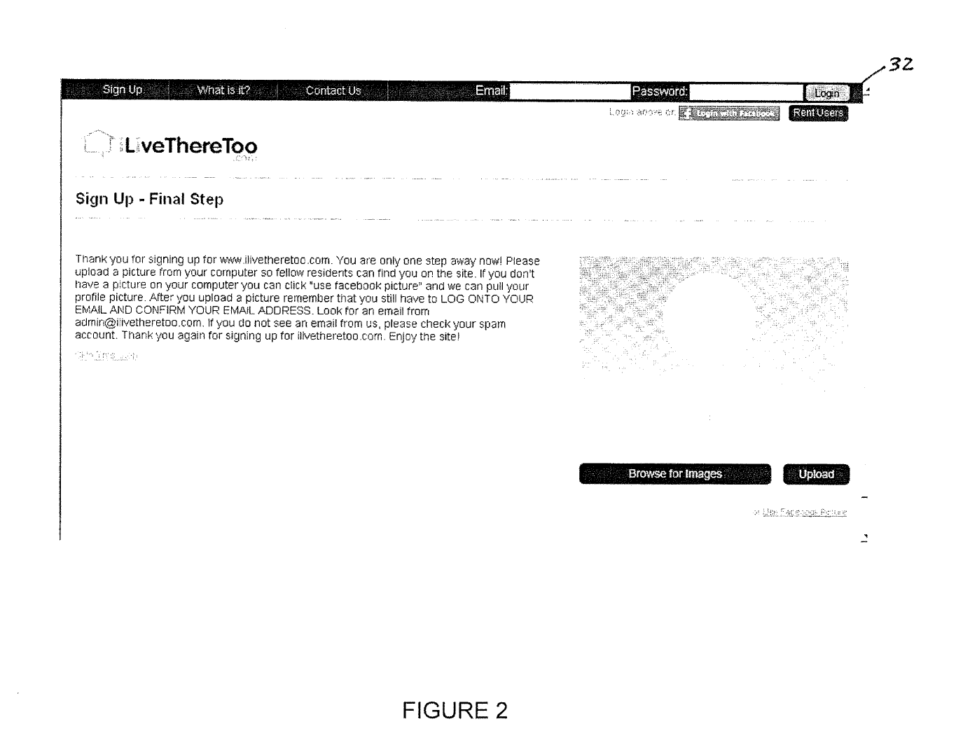

FIG. 1 illustrates a portion of a social connectivity system 10 according to one embodiment of the invention. The social connectivity system 10 can include an access page 12. In some embodiments, the access page 12 can enable one or more members, users, and/or prospective users to gain access to the social connectivity system 10. The access page 12 can include a series of fields in which a new or perspective user can input one or more pieces of personal information. For example, as shown in FIG. 1, the access page 12 can comprise a first name field 14, a last name field 16, a state drop-down menu 18, a city drop-down menu 20, a community drop-down menu 22, an e-mail address field 24, a password field 26, and a confirmatory password field 28. In some embodiments, users new to the social connectivity system 10 can input these pieces of personal information that can be used to create an account on the social connectivity system 10. In some embodiments, the access page 12 can comprise more or fewer fields so that the system 10 can receive more or less information than what is requested in FIG. 1. In some embodiments, after the new or perspective user inputs their information into the fields on the access page 12, the user can select the signup button 30 to continue the social connectivity system 10 account creation process. After selecting the signup button 30, in some embodiments, the social connectivity system 10 can display an image upload page 32 so that the new user can select an image of herself or himself to be displayed on the social connectivity system 10. In other implementations of the social connectivity system 10, organizations can create individual social network accounts when a resident joins the community organization. For example, in some embodiments a property manager may process a lease agreement with a resident of a residential complex or community. At the time the lease is signed or soon thereafter, organizations can create a new member account for the individual social network of the predetermined organization. Upon creation of the new member account, current members of the community organization are automatically connected as friends of the new member within the community-based social network.

In some embodiments, users, potential users, and/or new users can comprise members of a predetermined organization. For example, in some embodiments, the members of the predetermined organization can comprise residents of an apartment building, condominium complex, and/or any other residential building. As discussed in greater detail below, the social connectivity system 10 can enable its user to engage in social interactions and other communications and/or interactions with each other and management of the organization. Furthermore, in some embodiments, the members of the predetermined organization can comprise other persons or groups. For example, the members can comprise members, users, residents, renters, or other affiliates of at least one of a home owners' association, a gymnasium, a hotel, a business, a university, a college, a private club (e.g., a members-only golf and/or country club), a dues-charging organization, or any other defined organization (e.g., an organization defined by membership rules, residence in a building, complex, or other structure, use of a facility, etc.). Moreover, although examples disclosed herein refer to an apartment or residential complex, these discussions are not intended to limit the scope of the disclosure to this setting and the social connectivity system 10 can be employed in any of the previously mentioned contexts or any other suitable context or setting.

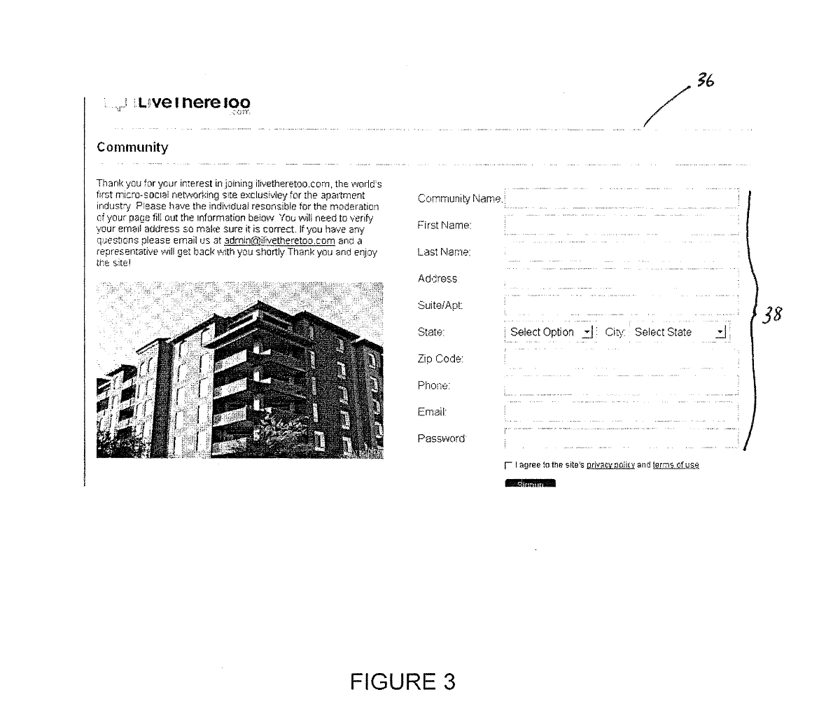

In some embodiments, the predetermined organizations can create individual social networks that are limited to members of the predetermined organization. As shown in FIG. 1, in some embodiments, an administrator of the predetermined organization can select a community button 34 on the access page 12 to enable creation of an account for the predetermined organization. After selecting the community button 34, the system 10 can display a community signup page 36, as shown in FIG. 3. The community signup page 36 can comprise a plurality of fields 38 into which the administrator can input biographical information regarding the predetermined organization. For example, as shown in FIG. 3, the administrator can input information regarding a residential community so that members and/or residents of the residential community can use the social connectivity system 10. After entering some or all of the information regarding the predetermined organization, the administrator can select the signup button 30 to add the predetermined organization to the list of available organizations on the community drop-down menu 22. By way of example only, in some embodiments, a property manager can add the property that they manage (e.g., an apartment complex or residential building) so that when residents of the property create an account to use the social connectivity system 10, the name or other property indicator can be displayed in the community drop-down menu 22 during account creation for the user.

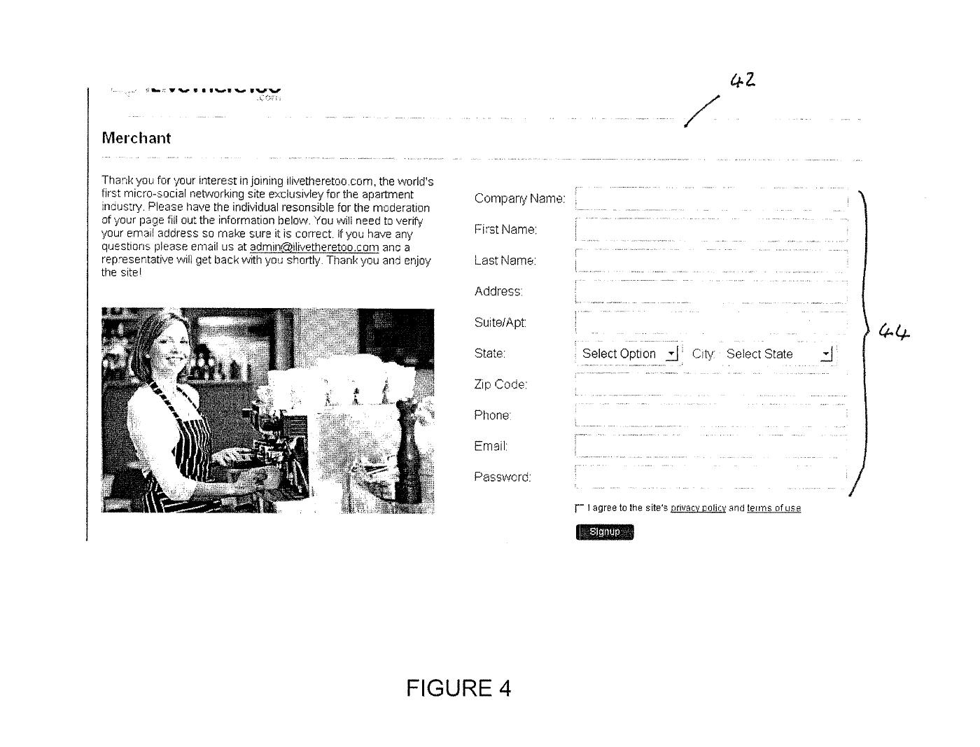

In some embodiments, the access page 12 can be configured and arranged to enable one or more merchants, advertisers, and/or any other business or organization to join or participate in the social connectivity system 10. For example, the access page 12 can comprise a merchant signup button 40, as shown in FIG. 1. After selecting the merchant signup button 40, the system 10 can display a merchant signup page 42, as shown in FIG. 4. The merchant signup page 42 can comprise a plurality of fields 44 into which an administrator of the merchant can input biographical information regarding the merchant or business. For example, as shown in FIG. 4, the administrator can input information regarding a merchant so that users of the social connectivity system 10 can view the advertising, branding, and/or other messaging provided by the merchant, as described in further detail below. After entering some or all of the information regarding the merchant, the administrator can select the signup button 30 to add the merchant to the social connectivity system 10.

In some embodiments, the access page 12 can comprise additional elements. For example, as shown in FIG. 1, in some embodiments, the access page 12 can include a visitor signup button 46 that can enable limited, substantial, and/or complete usage of the social connectivity system 10 without having to create a user account. Moreover, the access page 12 can also comprise an explanatory multimedia window 48. As shown in FIG. 1, a user, an administrator, or a potential user can view a multimedia presentation via the window 48 that can explain the usage and benefits of the social connectivity system 10. Furthermore, in some embodiments, the access page 12 can comprise a link 50 to other social media outlets (e.g., Facebook®) so that a user's profile on the social connectivity system 10 can be connected or linked with the user's other social media profiles. Additionally, in some embodiments, the access page 12 can comprise a username field 52 and password field 54 into which existing users can enter the user-specific username and password, respectively, to gain access to the social connectivity system 10.

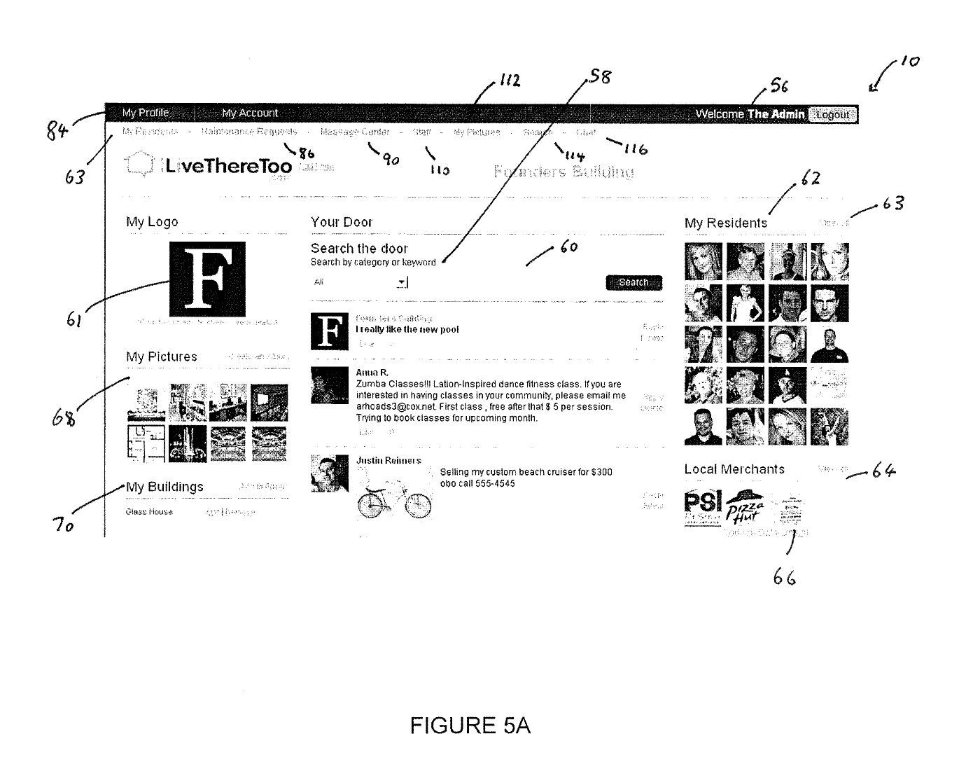

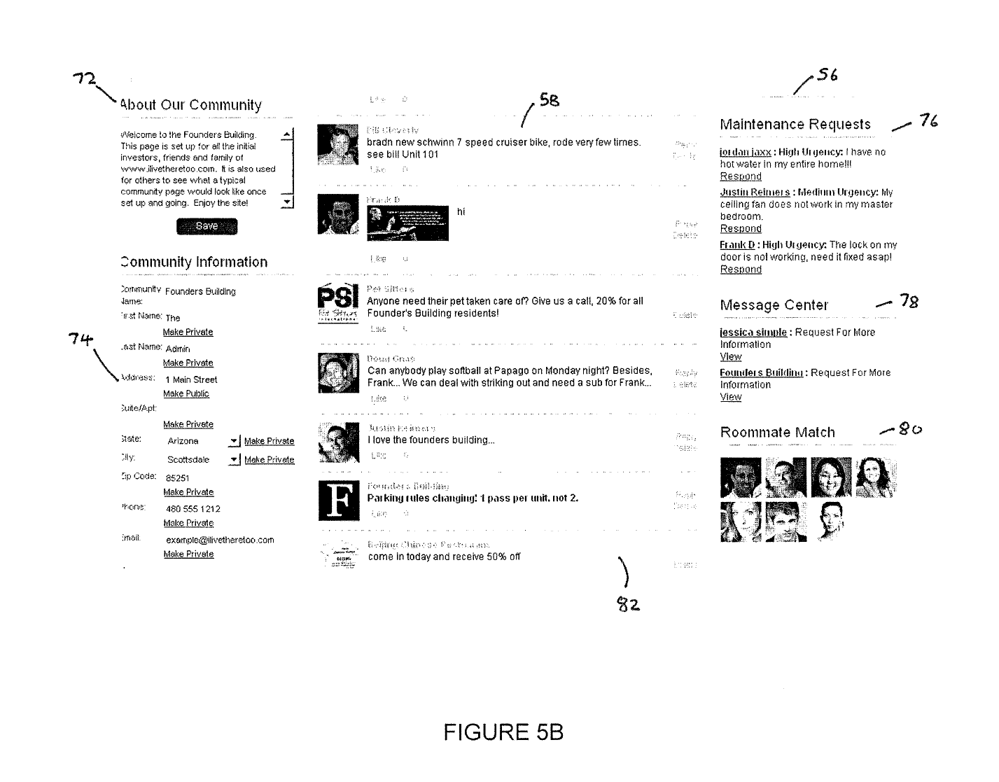

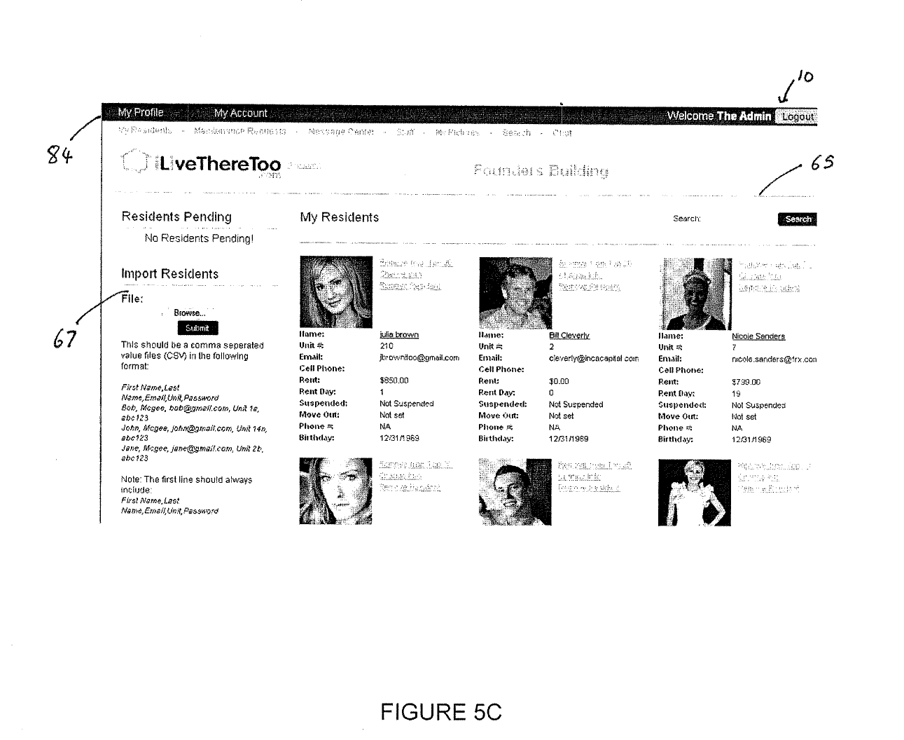

In some embodiments, after entering the user-specific username and password in to the username field 52 and password field 54, respectively, the social connectivity system 10 can display a home page 56, as shown in FIG. 5A. In some embodiments, the home page 56 can comprise multiple elements that can enable the users to interface with each other. For example, as shown in FIG. 5A, after creation of an account for the predetermined organization by the administrator, the system 10 can create a community communication board 58 for the organization (e.g., named “Your Door” in FIG. 5A). In some embodiments, the community communication board 58 can be configured so that users (e.g., residents of the residential building), can post information, statements, or other messages regarding any topic to the community communication board 58 that may interest any other residents (e.g., social gatherings, advertising for sale of personal goods and services, etc.). As a result of the inclusion of the community communication board 58, communication between the members of the predetermined organization can be improved to create a greater camaraderie among the members or users. Moreover, the communication entries in the community communication board 58 (e.g., text posts) can comprise names and images uploaded by the users and the administrator when creating their respective accounts on the image upload page 32, as previously mentioned. As a result, other users can readily identify other users who are posting comments on the community communication board 58. Additionally, the community communication board 58 can comprise a search field 60 so that users and the administrator can input search terms to sort through the postings on the community communication board 58.

In some embodiments, the home page 56 of the predetermined organization can comprise other elements. For example, the home page 56 can comprise an image field 61 so that the image uploaded during creation of the account can be displayed on the home page 56, as shown in FIG. 5A. Moreover, the home page 56 can also include a members roster 62 (e.g., labeled as “My Residents” in FIG. 5A). In some embodiments, the members roster 62 can display on the administrator's home page 56 so that the administrator can readily connect to each individual by selecting their image on the home page 56. Additionally, in some embodiments, the members roster 62 can comprise a link 63 to members page 65, as shown in FIG. 5C (e.g., labeled “My Residents” in FIG. 5C). In some embodiments, the members page 65 can comprise relevant information about each member of the predetermined organization that is a part of the system 10. For example, as shown in FIG. 5C, the predetermined organization can comprise a residential building and the members page 65 can comprise information regarding in which unit each resident resides, rent payments associated with each resident, phone numbers, and any other information that an administrator could deem relevant. Moreover, in some embodiments, the members page 65 can comprise an import field 67 so that the administrator can assemble a list of members in a predetermined file type (e.g., a .csv file) and import that file to populate the members page 65.

In some embodiments, the home page 56 can also comprise a merchant roster 64, as shown in FIG. 5A (e.g., labeled as “Local Merchants” in FIG. 5A). For example, after a merchant completes the items on the merchant signup page 42, a logo, brand, or other identifier can be displayed on the home page 56 so that users can select the merchant's icon to view goods or services offered for sale. Moreover, in some embodiments, the home page 56 can comprise a daily sales offering link 66 positioned adjacent to the merchant roster 64. For example, in some embodiments, the merchants can provide sales on goods and services that are offered for a limited time (e.g., one day) so that the users can select the daily sales offering link 66 to view those limited sales. Additionally, in some embodiments, the home page 56 can comprise an image roster 68 (e.g., labeled “My Pictures” in FIG. 5A). For example, the administrator and/or other users can upload one or more images or pictures to the system 10 that can be shared with some or all of the other users. Additionally, in some embodiments, the home page 56 can also comprise references to other predetermined organizations with which the user or administrator may be affiliated by displaying them in an organization roster 70 (e.g., labeled “My Buildings” in FIG. 5A).

Moreover, as shown in FIG. 5B, in some embodiments, the home page 56 can comprise additional elements. For example, the home page 56 can include an organizational explanatory field 72 that can comprise additional information about the predetermined organization that may attract others to join or become members of the predetermined organization. Additionally, in some embodiments, the administrator's home page 56 can comprise a plurality of fields 74 into which the administrator or other person can input relevant information regarding the predetermined organization that can be displayed on the organization's home page 56, as shown in FIG. 5B.

In some embodiments, as described in further detail below, one or more users can transmit one or more messages to the administrator to convey pertinent information to the administrator. By way of example only, in some embodiments, the users can transmit maintenance requests to the administrator. In some embodiments, the administrator's home page 56 can comprise a maintenance request alert region 76 so that the administrator can be apprised of the nature of maintenance requests and the level of urgency associated with each request. Moreover, in some embodiments, the administrator's home page 56 can also comprise a message center region 78 that can include messages or other information sent by users (e.g., residents) so that the administrator can address the needs of the users. Additionally, in some embodiments where the predetermined organization comprises a residential building or complex, the administrator's home page 56 can comprise a roommate match region 80 that can display to the administrator the residents who are roommates with each other. In some embodiments, the roommate match region 80 can enable the administrator to readily assess which residents are connected to each other.

Additionally, in some embodiments, the community communication board 58 can comprise in-content advertising 82. For example, as shown in FIG. 5B, in some embodiments, the system 10 can be configured and arranged so that in-content advertising messages 82 can be substantially or completely automatically generated and displayed on the community communication board 58. As shown in FIG. 5B, the in-content advertising 82 can comprise a substantially similar appearance to the other communications, messages, and/or postings created by the users. In other embodiments, in-content advertising information may be rendered with minor background color alterations, for example in one embodiment the font and font size may be substantially identical to member communications posted on the community communication board 58, however the font background color may be changed to yellow or some other color that contrasts with the rendered background color, and/or font color.

Moreover, in some embodiments, the in-content advertising can be repeated at regular intervals (e.g., for every three messages submitted by a user, one in-content advertisement 82 can be automatically posted). As a result, as the users review the community communication board 58, the in-content advertising 82 can be reviewed along with some or all of the other commentary posted to the board 58. In some embodiments, administrators of the system 10 or the predetermined organization can coordinate with the merchants to create the in-content advertising 82. Moreover, in some embodiments, the administrators can receive advertising fees from the merchants for the in-content advertising 82 to at least partially offset the costs of system 10 administration.

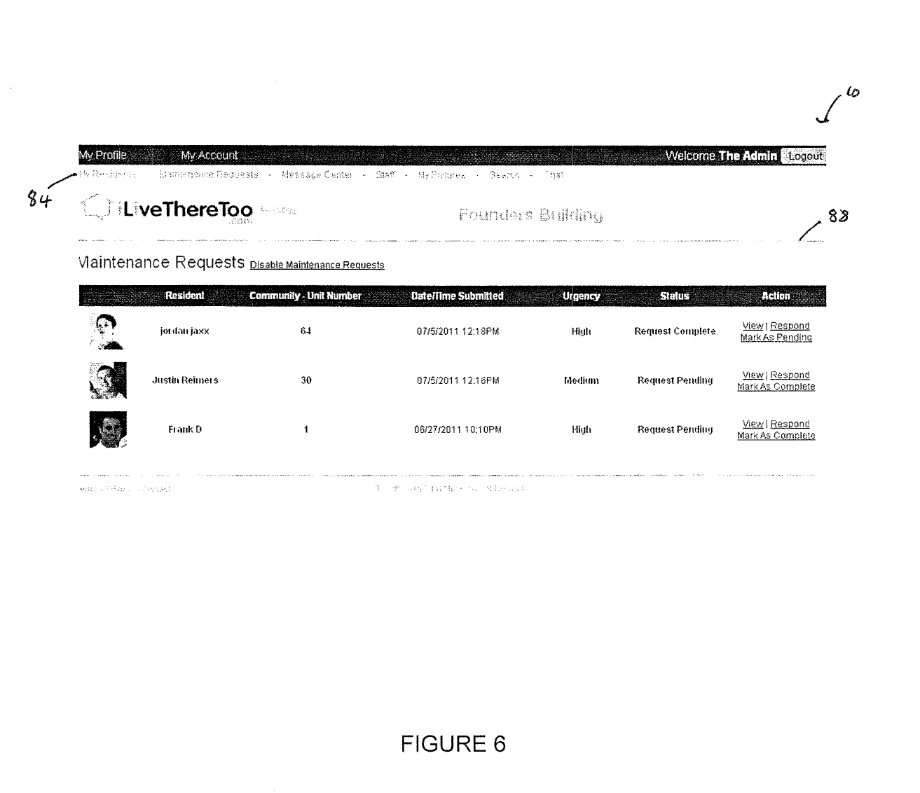

In some embodiments, the home page 56 can also comprise a menu 84, as shown in FIG. 5A. In some embodiments, on the administrator's home page 56, the menu 84 can comprise a plurality of links to other resource pages that can aid the administrator in maintaining the predetermined organization. For example, in some embodiments, the menu 84 can comprise an additional link 63 to the members page 65 so that the administrator can view information specific to each user. In some embodiments, the menu 84 can comprise a maintenance request link 86 that, when selected, can display a maintenance request page 88. As shown in FIG. 6, the maintenance request page 88 can comprise a display of information regarding one or more maintenance requests placed by users. For example, as previously mentioned, in some embodiments, the predetermined organization can comprise a residential building or complex and one or more of the residents may need to submit maintenance requests (e.g., to request repair or maintenance of various elements of the dwellings or units). After receiving the maintenance requests, the system 10 can display the requests and all related information on the maintenance request page 88, in addition to or in lieu of displaying the maintenance request information on the home page 56, as previously mentioned. As well as serving as an efficient and dynamic tool for the members to resolve maintenance problems within their residence and/or community building, the maintenance request process serves as an audit trail in the event there should be a need to access the time and date of the maintenance request, the specifics of the maintenance problem, and whether or not maintenance was performed adequately, and any further communications between the member and community organization and/or community property manager.

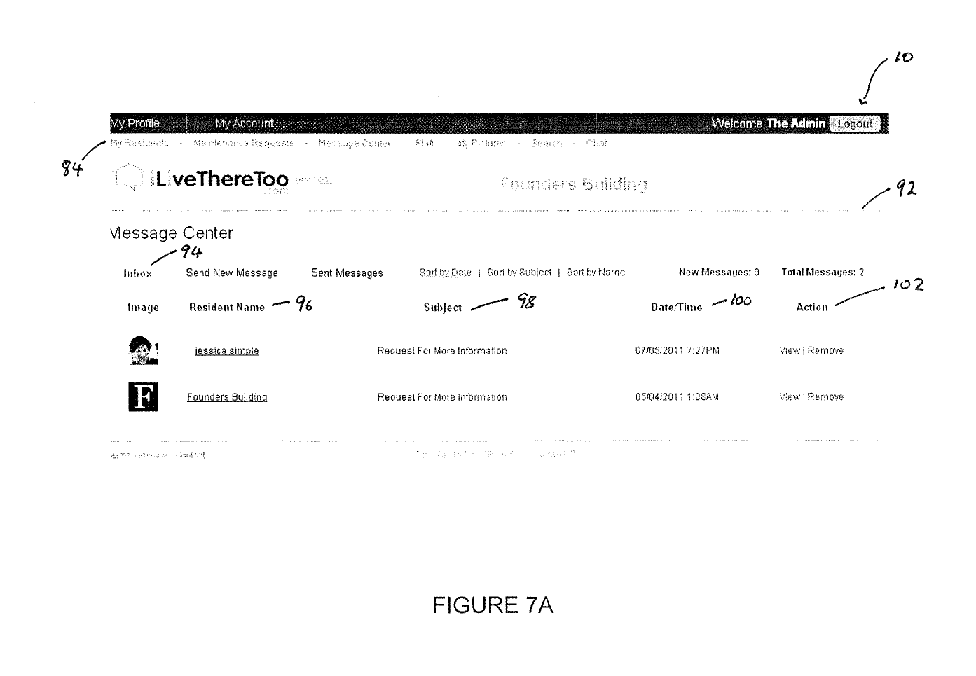

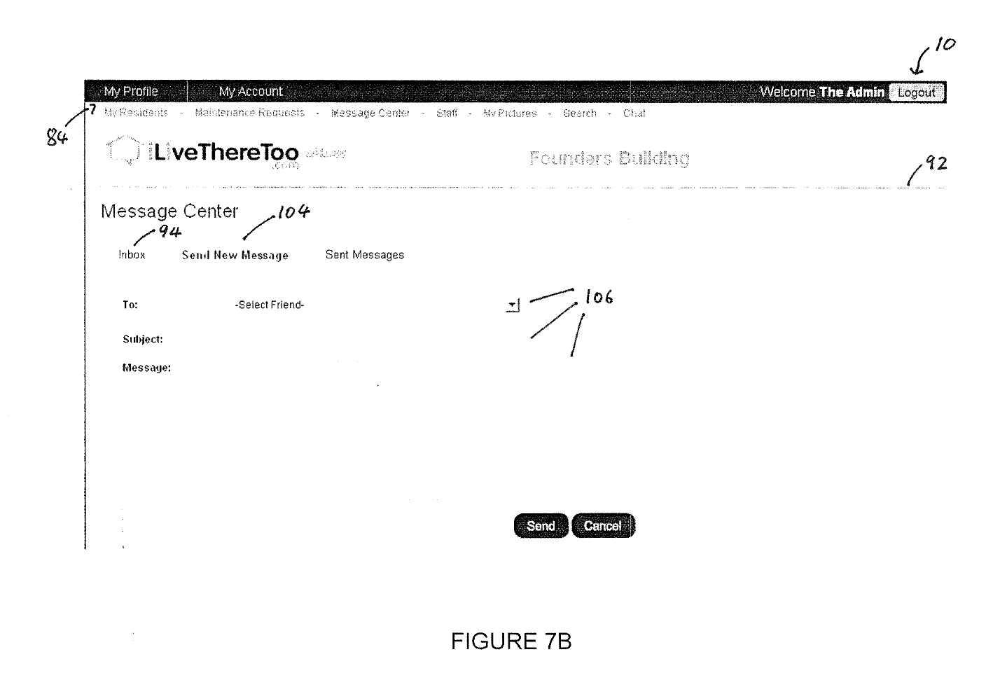

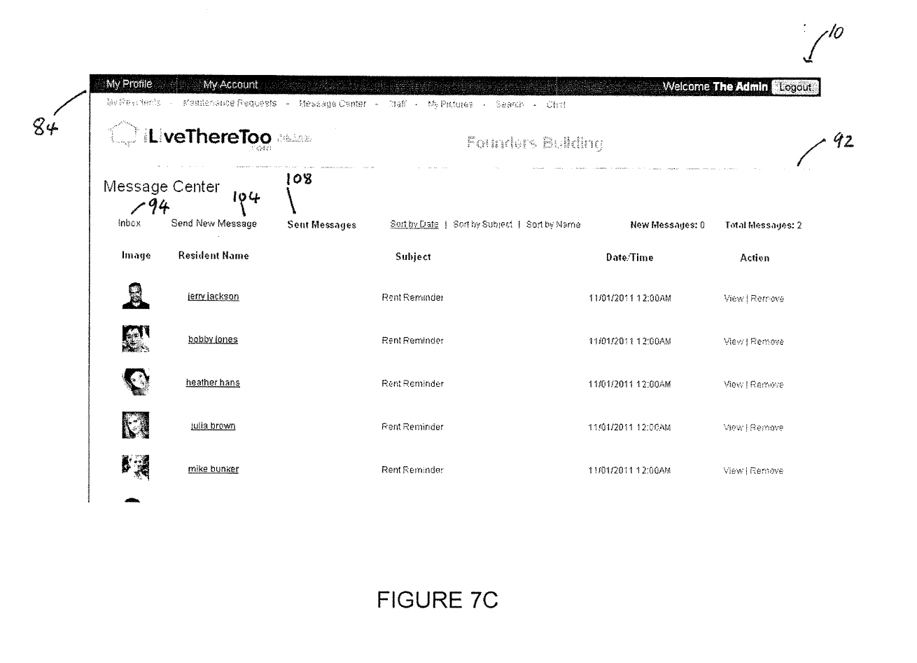

In some embodiments, the menu 84 can comprise a message center link 90 that, when selected, can display a message center page 92. As shown in FIG. 7A, the message center page 92 can comprise a display of messages that have been sent to and/or from the user and/or administrator's account. For example, as shown in FIG. 7A, the message center page 92 can comprise an inbox 94 that can include messages received by the user and/or administrator, including a name of the sender 96, a subject of the message 98, a date/time of receipt 100, and action to be taken 102. By way of example only, in some embodiments, a user can send the administrator a message regarding any subject and that message can be displayed in the inbox 94 for the administrator's review. Moreover, in some embodiments, users can send messages to other users (i.e., non-administrators) for directed and/or private communication.

As shown in FIG. 7B, the message center page 92 can also comprise a send new message tab 10. Any user can select the send new message tab 104 to draft and send a message to the administrator and/or other users for communications by entering text into message fields 106. Furthermore, users of the system 10 can monitor the messages that have been sent from their account by selecting a sent messages tab 108 on the message center page 92. As a result, the user can assess the number and nature of messages previously sent from their message center page 92. For example, in some embodiments, the administrator can draft and send messages to all members (e.g., residents) about certain recurring events, such as due dates for payments (e.g., rent payments), as shown in FIG. 7C.

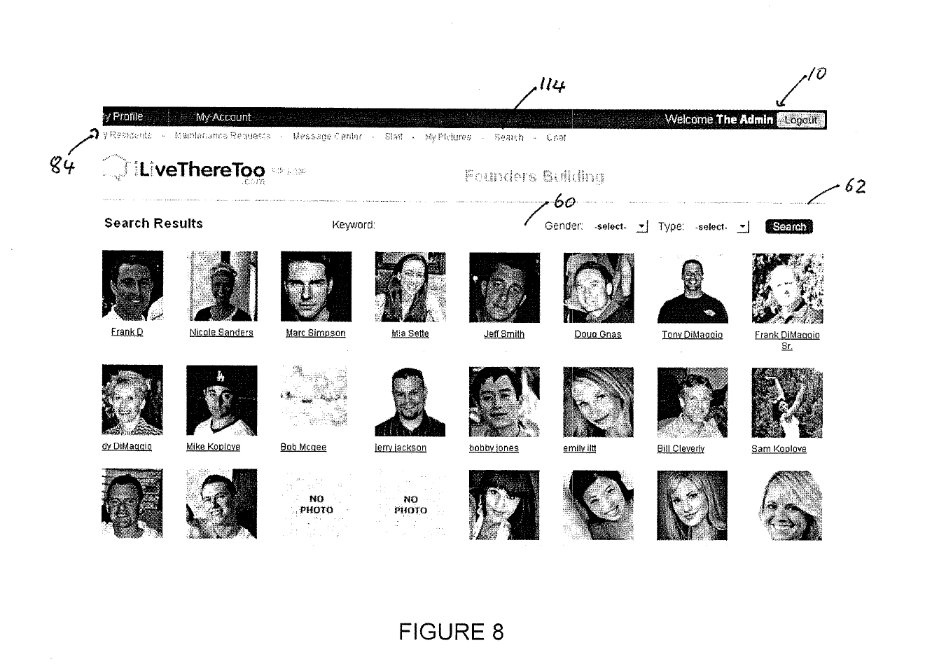

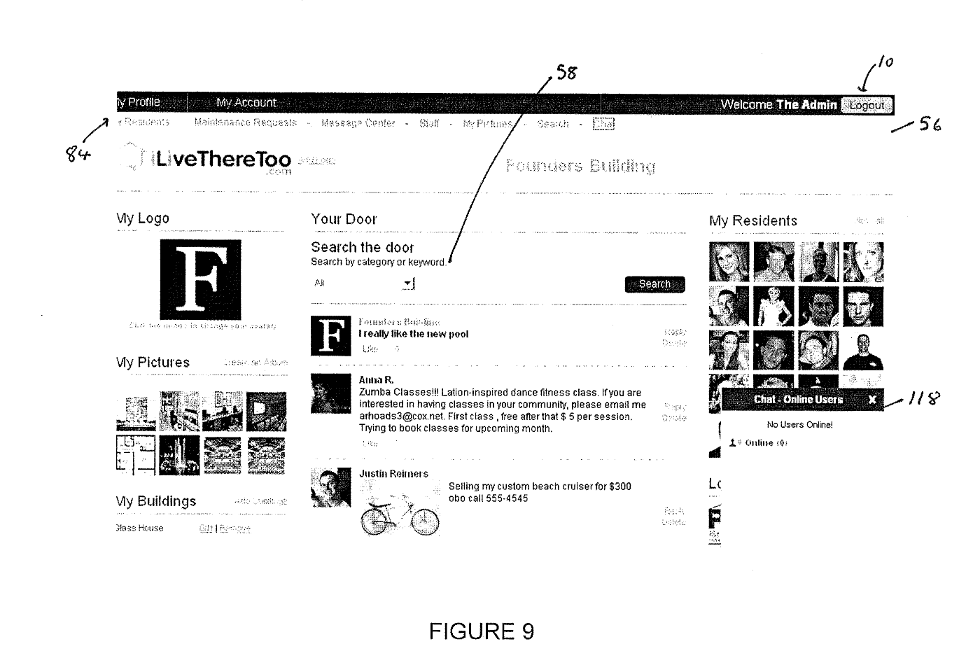

In some embodiments, the menu 84 can comprise additional elements. For example, the menu 84 can comprise a link to a staff page 110 so that users and/or the administrator can view the status or relevant pages of the staff members who work for and/or with the predetermined organization. In some embodiments, the menu 84 can also comprise an images link 112 that can be selected to view all of the users and/or administrators stored images. Additionally, the menu 84 can comprise a search link 114 that can be selected to search for some or all of the users or members of the predetermined organization, as shown in FIG. 8. For example, the user can input one or more search terms into the search field 60 to find users or members based on the search terms. Furthermore, in some embodiments, the menu 84 can comprise a chat link 116 that can be selected to open a chat dialogue box 118, as shown in FIG. 9. For example, in some embodiments, after opening the chat dialogue box 118, the user can chat with one or more users or members that are currently using the system 10. As a result, the users can communicate with each other in real time or near real time.

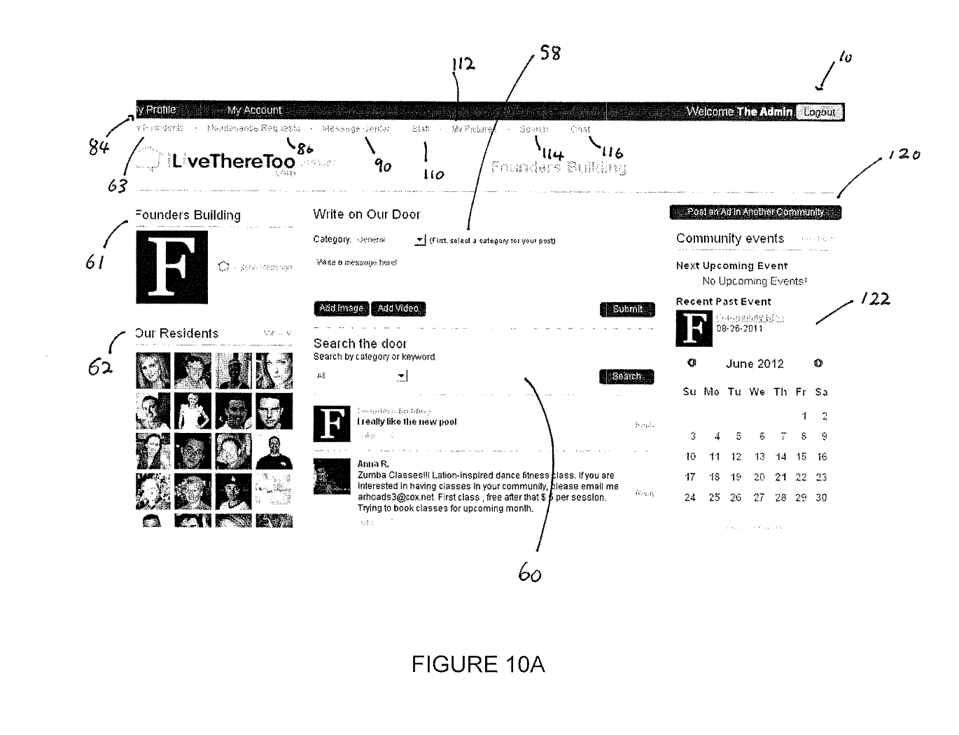

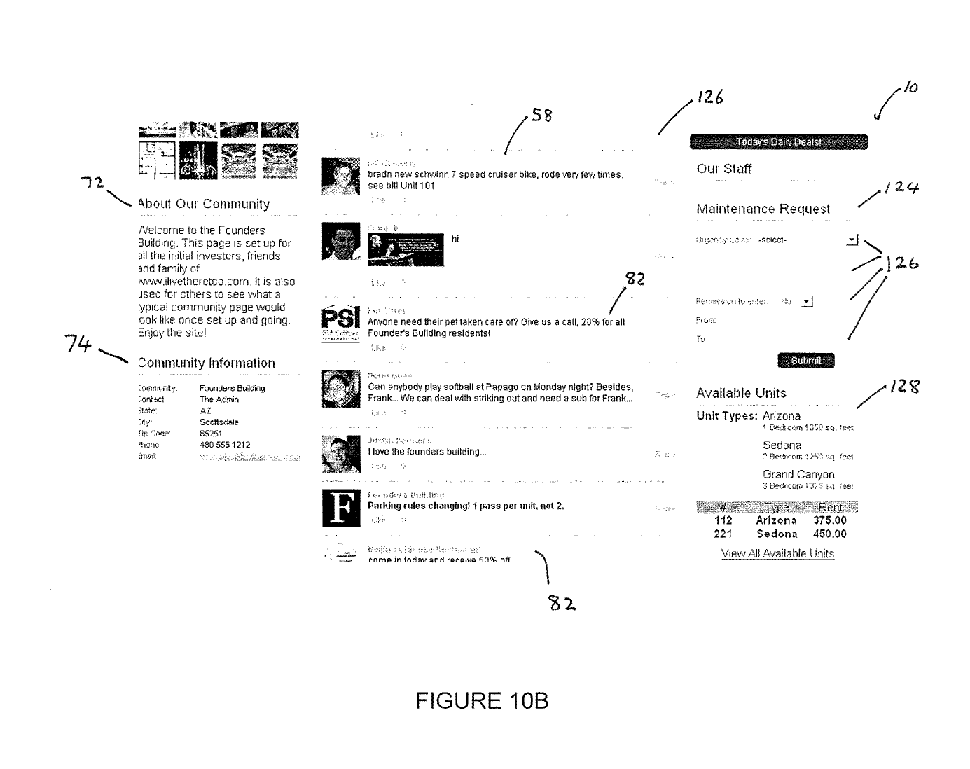

As shown in FIG. 10A, other pages of the system 10 can comprise additional elements. For example, in some embodiments, the system 10 can comprise a community page 120. In some embodiments, the community page 120 and the home page 56 can be substantially similar or the same. For example, for some or all of the non-administrators with access to the system 10, the community page 120 can be the same as the home page 56 (e.g., can comprise the members roster 62, the merchant roster 64, the community communication board 58, in-content advertising 82, etc.). In some embodiments, the administrator's home page 56 can be substantially or completely different than the community page 120.

In some embodiments, the community page 120 can comprise multiple elements. For example, the community page 120 can comprise a community events calendar 122 so that members of the predetermined organization have notice of the different social events occurring at any given time, as shown in FIG. 10A. Moreover, a user can select or click on each day of the calendar to see the events that occur on any given day. Additionally, in some embodiments, the community page 120 can comprise the staff line 110 and a maintenance request entry region 124. For example, as shown in FIG. 10B, in some embodiments, the users can enter the nature of their maintenance requests into fields 126 of the maintenance request entry region 124 and transmit those requests to the administrator, including the level of urgency, the maintenance needed, and the user submitting the request. Once received, the maintenance information can be displayed on the administrator's home page 56 and on the maintenance request page 88. Additionally, as shown in FIG. 10B, in some embodiments, the community page 120 can identify units of the predetermined organization that are for sale or rent. For example, in embodiments where the predetermined organization comprises a residential complex, the community page 120 can comprise a rental region 128 that can identify different residential units that are for rent, sale, or lease.

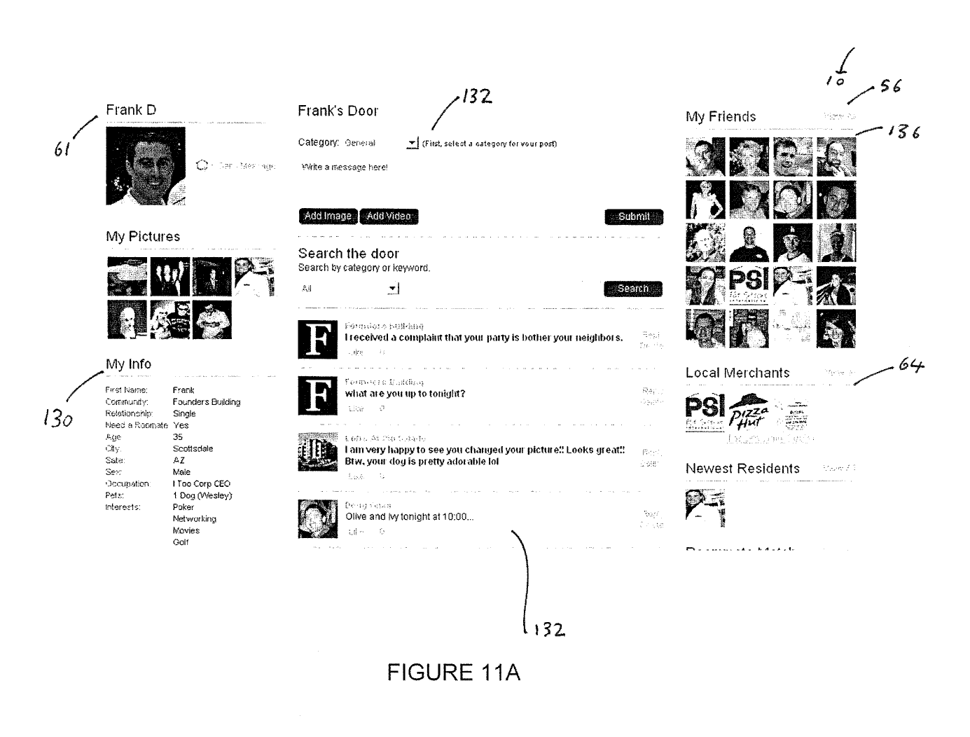

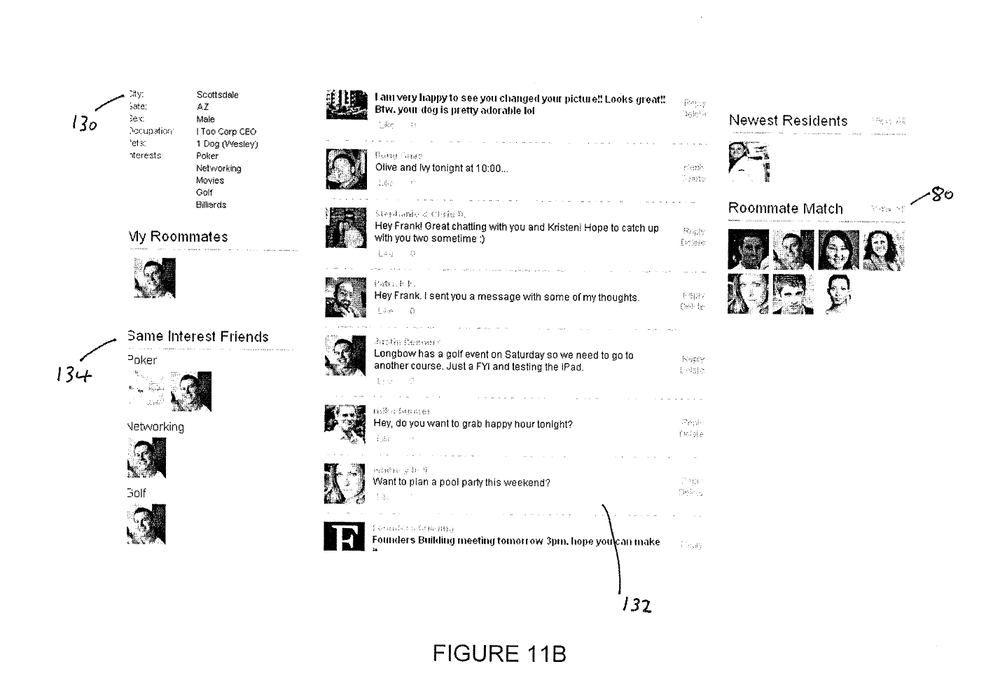

In some embodiments, the system 10 can create a home page 56 for some or all of the users and/or members of the predetermined organization, after they create an account, as shown in FIG. 11A. In some embodiments, the home page 56 can comprise some similarities to the community page 120. For example, in some embodiments, the user's home page 56 can comprise an image field 61 that can display the image selected by the user during the initial account creation process. Moreover, in some embodiments, home page 56 can comprise the image roster 68, which includes images added by the user. In some embodiments, some or all of the user's home pages 56 can comprise a personal communication board 132 (e.g., labeled “Frank's Door” in FIG. 11A, and labeled “My Door” in FIGS. 13-23). In some embodiments, the personal communication board 132 can be used by one or more members to post messages or information that may be of interest to the user to which the personal communication board 132 belongs. For example, a message intended for the user can be posted to the personal communication board 132 in lieu of or in addition to posting the message to the community communication board 58. As a result, the user can readily receive the message. For example, in some embodiments, the personal communication board 132 can be connected to a first user's personal email address so that when a second user posts a message to the personal communication board 132 of the first user, the first user can receive a notification of the posting. In some embodiments, similar to the community communication board 58, the personal communication board 132 can comprise in-content advertising 82 in a manner substantially similar the in-content advertising 82 that was previously mentioned.

Further, in some embodiments, the home page 56 can include a biographical data region 130 that can display information entered about the user. For example, as shown in FIG. 11A, the biographical data region 130 can comprise information such as the user's name, relationship status, age, address, sex, and interests. By way of example only, in some embodiments, the system 10 can be configured and arranged to process the interests inputted by each user, resident, and/or member and associate users with similar interests into one or more groups or subgroups, as shown in FIG. 11B. In some embodiments, the home page 56 can comprise a related interest region 134 that can include the names and/or representative images of some or all of the users with similar and/or the same interests as the user who is viewing their home page 56 (i.e., the system 10 can associate the users with similar or the same interests in a subgroup). In some embodiments the interest association process occurs when the user completes a new member profile and may be entered optionally by the member. The member may opt to enter one or more interests, and all other friends with same interests are then displayed. As a result, the users and members of the predetermined organization can more readily relate, interact, and socialize with others of like interests compared to embodiments that do not include the related interest region 134.

Additionally, in some embodiments, the home page 56 can also comprise a friends region 136. As shown in FIG. 11A, in some embodiments, a portion of the users can associate themselves into a group of friends and the images associated with those users can be displayed in the friends region 136. As a result, the user can access the home pages 56 of their friends and can post comments on others' personal communication boards 132.

In some embodiments, the social connectivity system 10 can comprise alternative embodiments, as shown in FIGS. 12-23. For example, at least some of the previously mentioned embodiments can be accessed using a conventional personal computer. However, in some embodiments, the social connectivity system 10 can be configured and arranged to be accessed using any other suitable electronic device (e.g., a tablet computer, a personal digital assistant, a personal navigation or automobile navigation system, a smart phone, or other mobile or hand-held device, or alternatively, within another substantially fixed-location device within the home or office, such as a refrigerator, or other kitchen appliance, a television, a DVD player, a set-top box, or within a multimedia system attached to, or embedded in the structure of a building). For example, in some embodiments, the social connectivity system 10 can be configured to be used in connection with a smart phone or similar mobile device, as shown in FIGS. 12-23. In some embodiments, the social connectivity system 10 can comprise substantially similar or the same functionalities as at least some of the previously mentioned embodiments, but displayed in a different form configured for any of the devices listed above.

Turning now to some embodiments designed for mobile viewing and access of the social connectivity system 10 as described above, FIG. 12 shows an image of a mobile access page as a portion of a social connectivity system 10 according to one embodiment of the invention. In some embodiments, the access page 12 can enable one or more members, users, and/or prospective users to gain access to the social connectivity system 10. The access page 12 can include a series of fields in which a new or prospective user can input one or more pieces of personal information. For example, as shown in FIG. 12, the access page 12 can comprise, in some embodiments, a username field 52 and password field 54 into which existing users can enter the user-specific username and password, respectively, to gain access to the social connectivity system 10. In some embodiments, users new to the social connectivity system 10 can input these pieces of personal information that can be used to create an account on the social connectivity system 10. In some embodiments, the access page 12 can comprise more or fewer fields so that the system 10 can receive more or less information than what is requested in FIG. 12.

Moreover, in some embodiments, users accessing the social connectivity system 10 can make additional use of the social connectivity system 10, although other embodiments of the invention can also comprise at least a portion of the following functionalities. For example, as shown in FIG. 13, in some embodiments, the home page 56 can comprise a payment icon 138. In some embodiments, during the account creation process, the user can provide the connectivity system 10 with financial institution information so that the user can access funds within their own accounts for payments. By way of example only, in some embodiments, the payments can be transferred to the administrator for payments. This payments may be rent, lease or other fees associated with rental apartments, or other fees such as home-owners associated (“HOA”) fees, or mortgage payments associated with owner-occupied residences for example.

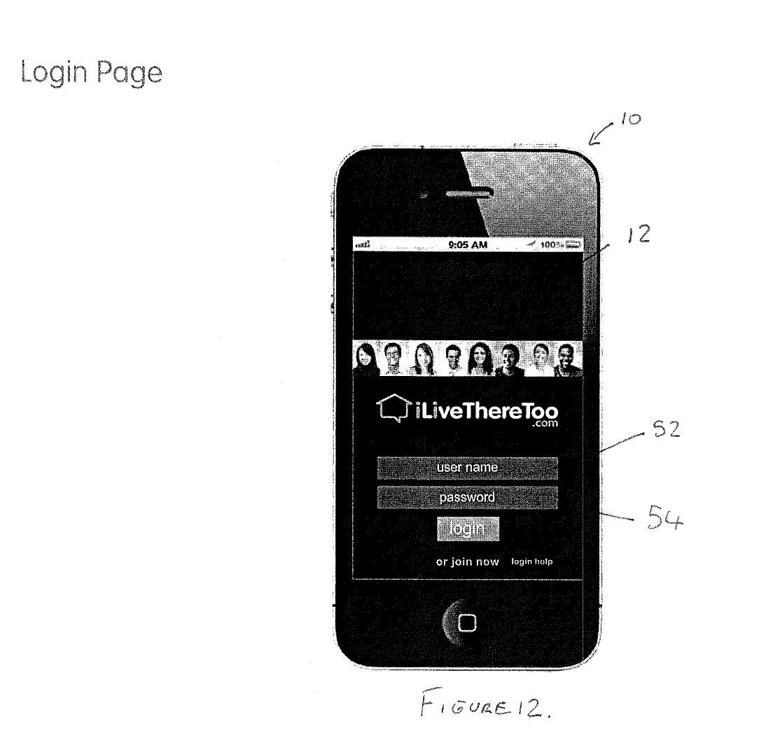

In some further embodiments, the community communication board 58 can comprise in-content advertising 82 on mobile devices. For example, as shown in FIG. 14B, in some embodiments, the system 10 can be configured and arranged so that in-content advertising messages 82 can be substantially or completely automatically generated and displayed on the community communication board 58. Moreover, as shown in FIG. 14B, the in-content advertising 82 can comprise a substantially similar appearance to the other communications messages and/or postings created by the users. As described earlier, in-content advertising messages 82 can comprise a substantially similar appearance to the other communications, In other embodiments, in-content advertising information may be rendered with minor background color alternations, for example in one embodiment the font and font size may be substantially identical to member communications posted on the community communication board 58 however the font background color may be changed to yellow, or some other color that contrasts with he rendered background color.

Moreover, in some embodiments, the in-content advertising can be repeated at regular intervals (e.g., for every three messages submitted by a user, one in-content advertisement 82 can be automatically posted). As a result, as the users review the community communication board 58, the in-content advertising 82 can be reviewed along with some or all of the other commentary posted to the board 58. In some embodiments, administrators of the system 10 or the predetermined organization can coordinate with the merchants to create the in-content advertising 82. Moreover, in some embodiments, the administrators can receive advertising fees from the merchants for the in-content advertising 82 to at least partially offset the costs of system 10 administration.

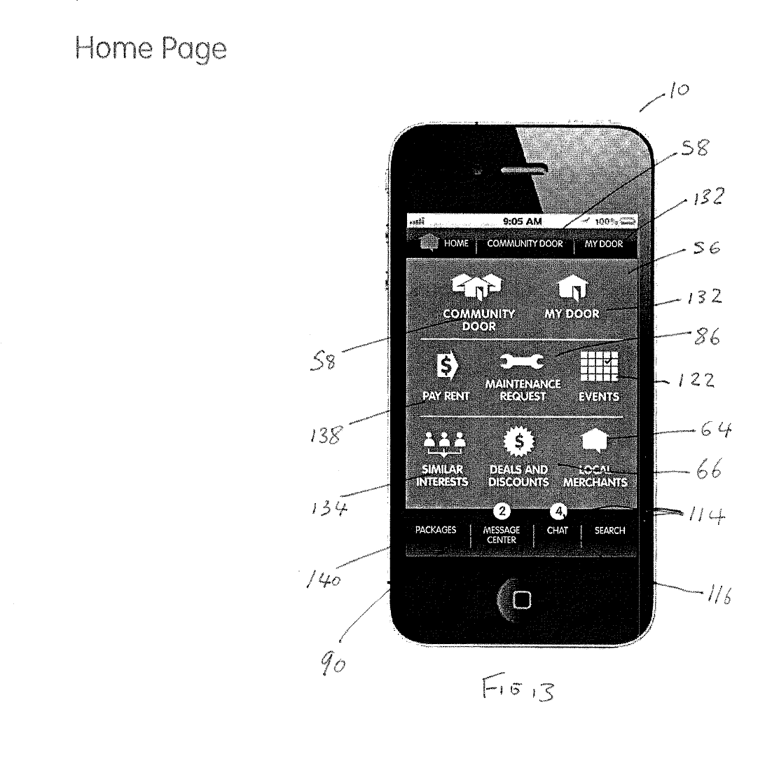

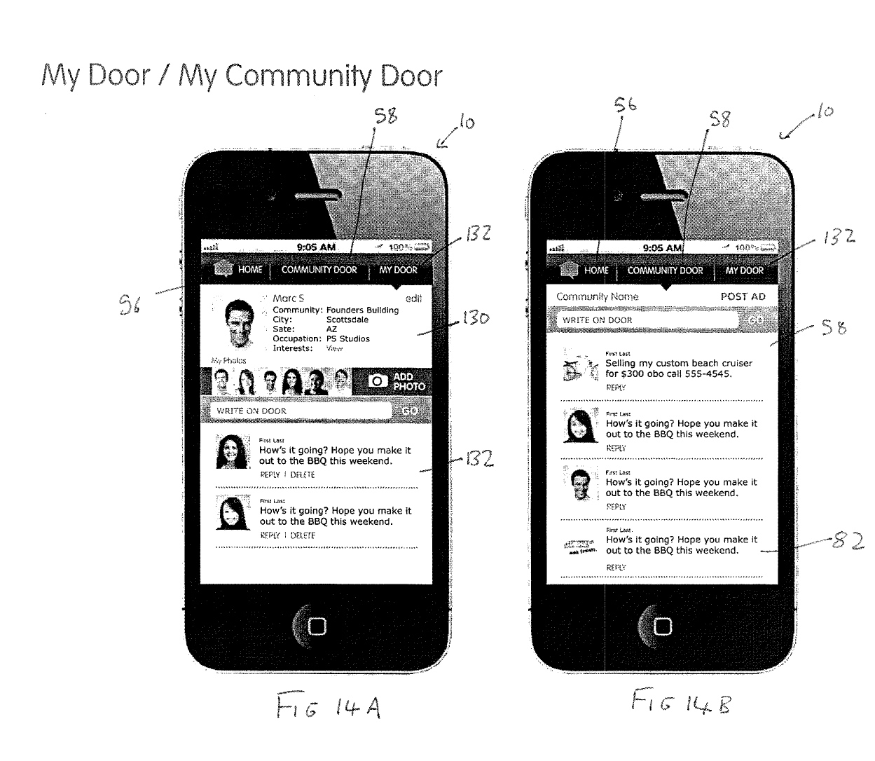

In other embodiments configured for use with mobile devices, versions of the social connectivity system 10 allow the user access to the friends page 136 and the related interests page 134. For example, FIG. 15A is shows an image of a mobile device version of a friends page 136 according to one embodiment of the invention, and FIG. 15B is an image of a related interests page 134 according to one embodiment of the invention. Similar to the information available in some embodiments shown in FIG. 11B, the related interests page 134 can include the names and/or representative images of some or all of the users with similar and/or the same interests as the user who is viewing their home page 56.

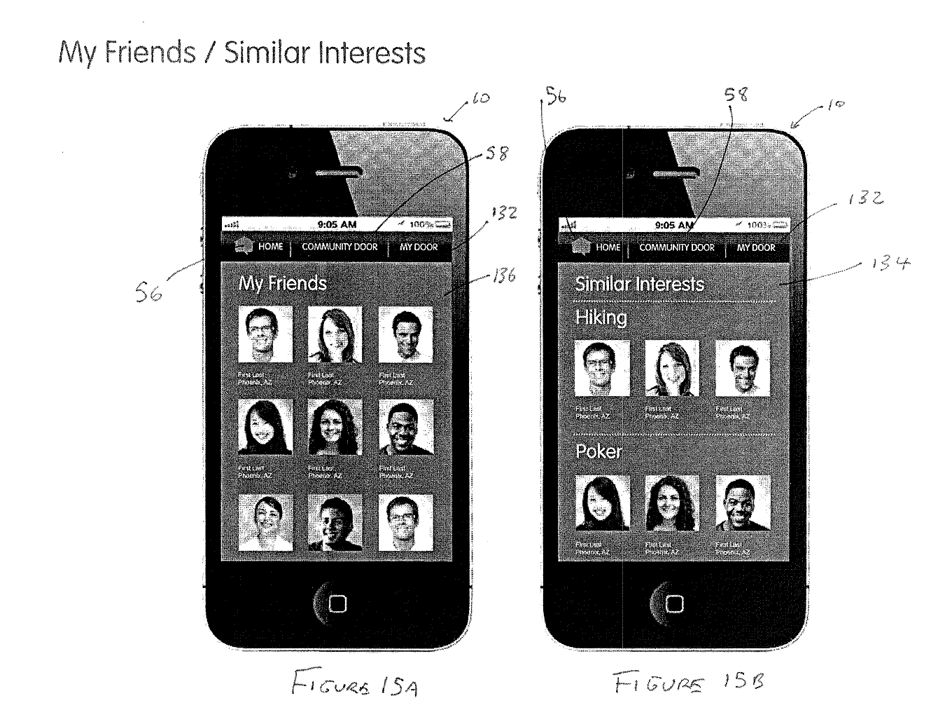

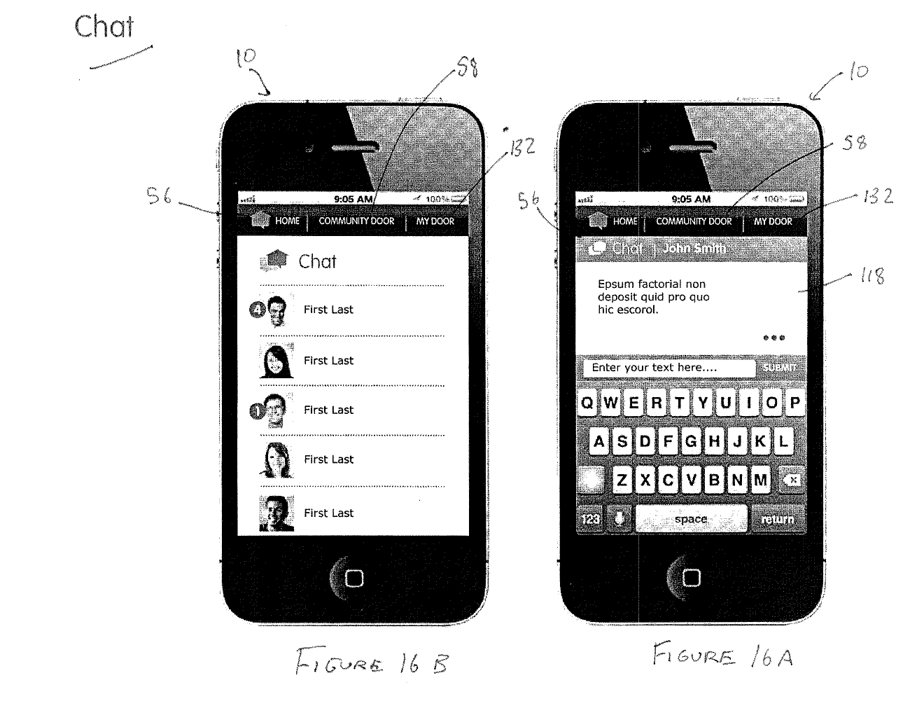

FIG. 16A is an image of a chat dialogue box according to one embodiment of the invention, and FIG. 16B is an image of a chat group member listing according to one embodiment of the invention. In some embodiments the social connectivity system may deploy a commercially available instant chat plug-in feature to enable the features as shown in FIGS. 16A and 16B. As shown in FIG. 16B, in some embodiments a member may access a plurality of members from a member list, and initial a chat session with one or more members by selecting their first or last names, or by selection of their representative image. Following this selection process, the member chat dialogue box 118 (as depicted in FIG. 16A) may be used to perform an instant chat communication with one or more of the members selected from the member list as shown in FIG. 16B.

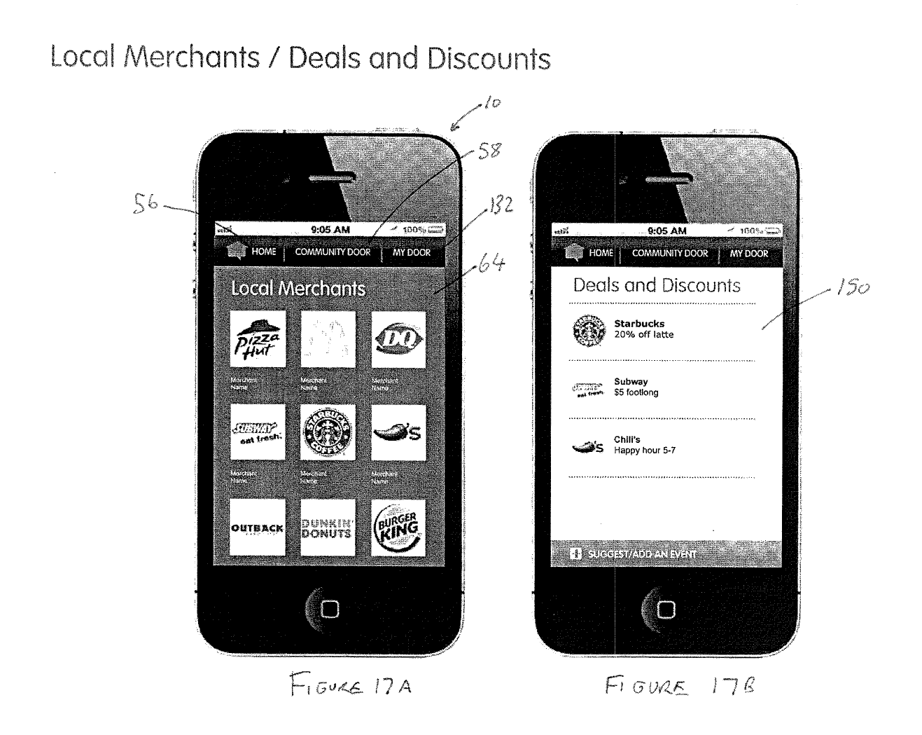

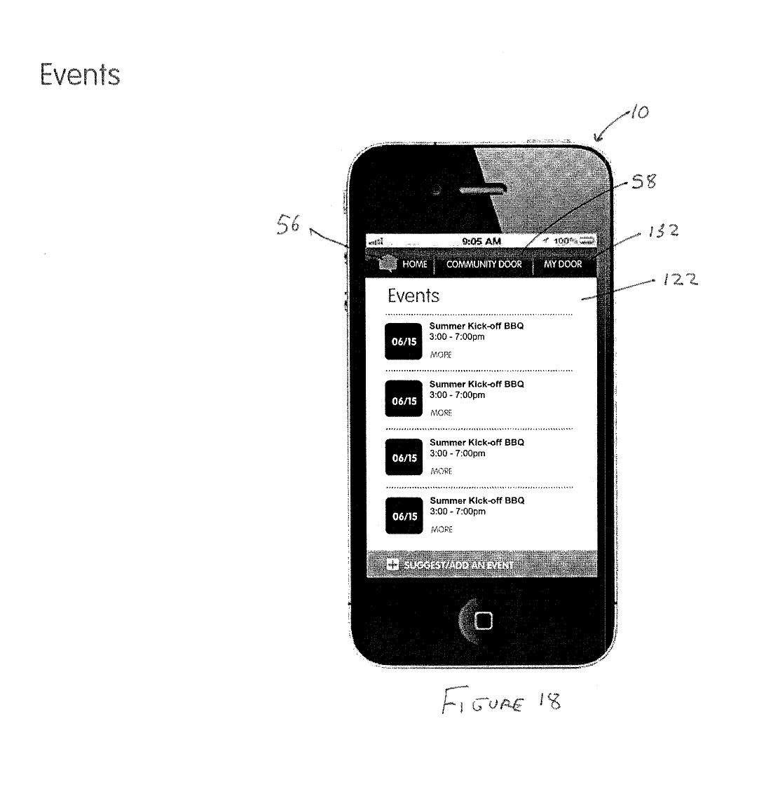

Furthermore, in some embodiments, the home page 56 can comprise a merchant roster 64, as shown in FIG. 17A (e.g., labeled as “Local Merchants” in FIG. 17A). For example, after a merchant completes the items on the merchant signup page 42, a logo, brand, or other identifier can be displayed on the home page 56 so that users can select the merchant's icon to view goods or services offered for sale. Moreover, in some embodiments, the home page 56 can comprise a daily sales offering link 66 positioned adjacent to the merchant roster 64, from which a user would have the opportunity to jump directly to the daily sales offerings, for example see FIG. 17B, which shows an image of the daily sales offering page 150, (labeled as “Deals and Discounts” in FIG. 17B), wherein a logo brand, or other identifier can be displayed adjacent to a sales offering. In some alternative embodiments, the daily sales offering page 150 would be available directly from the home page 56, (for example, FIG. 13 shows deals and discounts 66 on the home page), and there would be no need for the user to first select the merchant roster 64, as shown in FIG. 17A (e.g., labeled as “Local Merchants” in FIG. 17A).

In other embodiments pages of the system 10 can comprise a community events calendar 122 so that members of the predetermined organization have notice of the different social events occurring at any given date and time. For example, FIG. 18 is an image of a community events calendar displayed on a mobile device according to one embodiment of the invention.

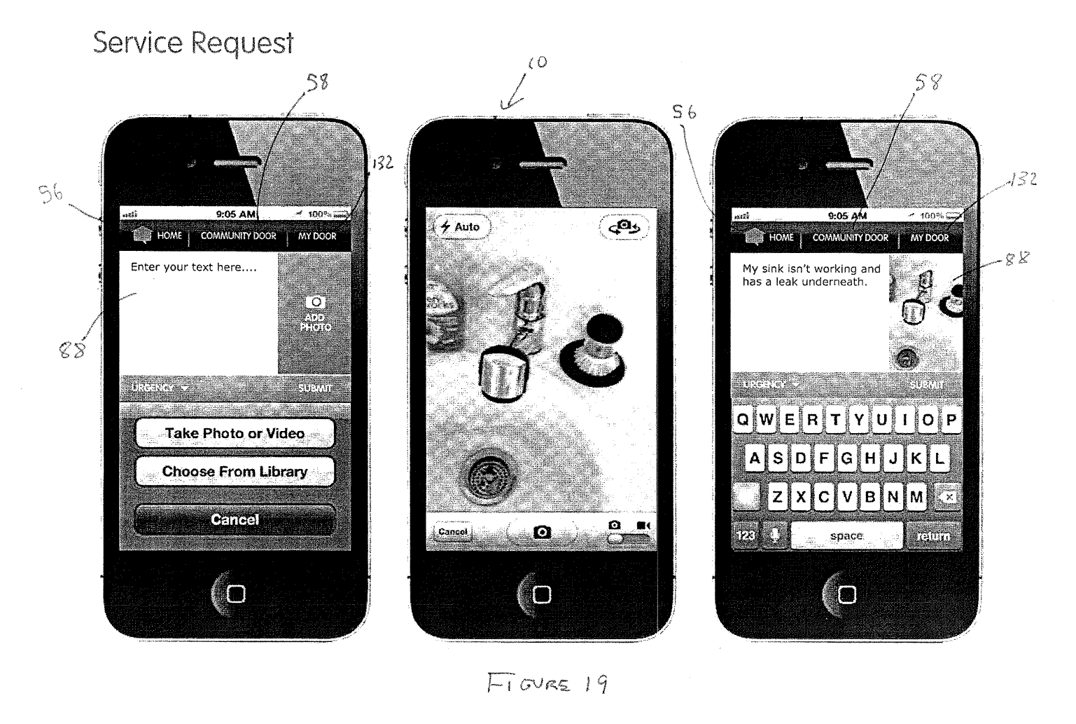

Conventional smart phones and other mobile devices often comprise the capability to capture photographs or video, or both. Through this photo-imaging functionality, in some embodiments the user may have the ability to attach a photograph, or video of any issues associated with a submitted maintenance request within their residential unit, building or complex, or community, which can improve the ability of the administrator to assess the problem that has resulted in the user submitting the maintenance request. This is illustrated in detail in FIGS. 19 and 23, showing a series of images illustrating submission of a maintenance request using a maintenance request page according to one embodiment of the invention, (FIG. 19), and a maintenance request page according to one embodiment of the invention, (FIG. 23).

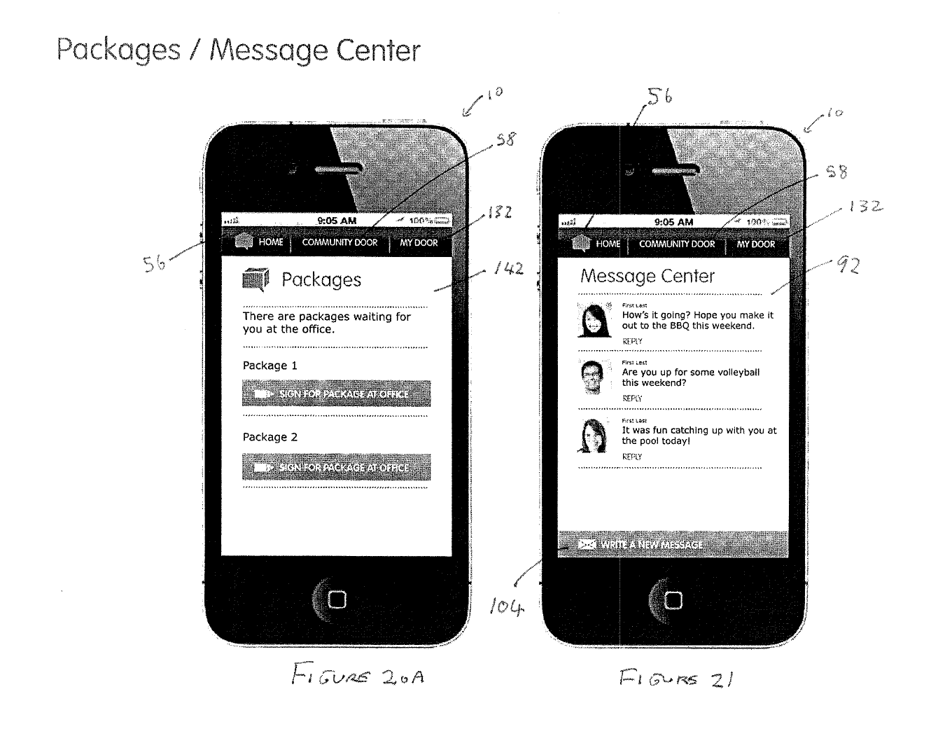

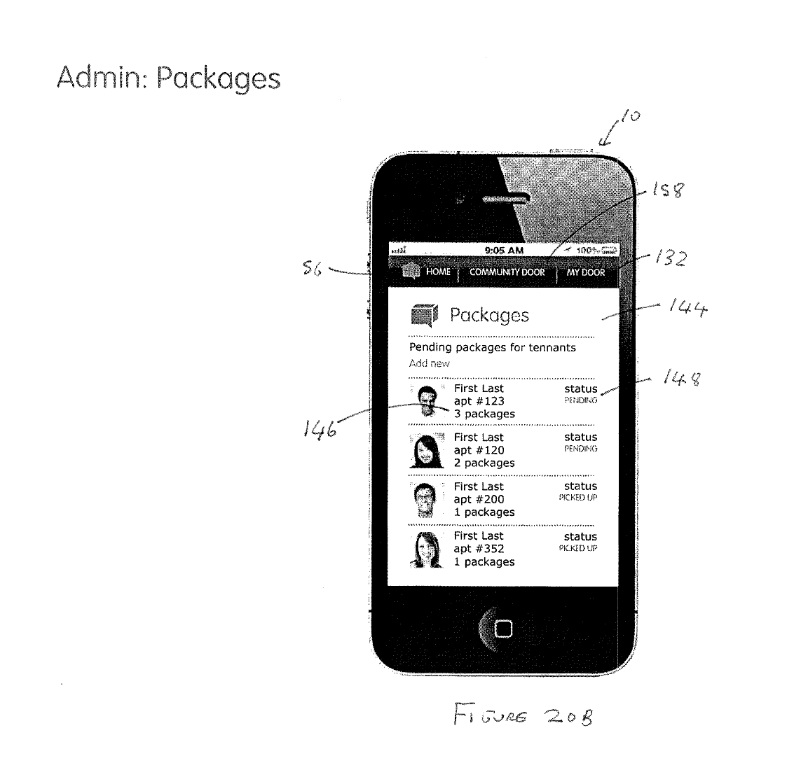

Furthermore, in some embodiments, the home page 56 can comprise other elements. For example, as shown in 20A, the home page 56 can comprise a package link 140 that can direct the user to a package pickup page 142. In some embodiments, the administrator can receive one or more packages for a user and, using the social connectivity system 10, the administrator can communicate to the user that his or her packages are ready to be picked up by sending a package notification message to the users package pickup page 142. As a result, the administrator can more easily communicate the need to pick up the package to the user, and transfer further package pickup information. For example, as shown in FIG. 20B, a package status page 144 is configured to show the number of packages 146, and the status of the pickup 148.

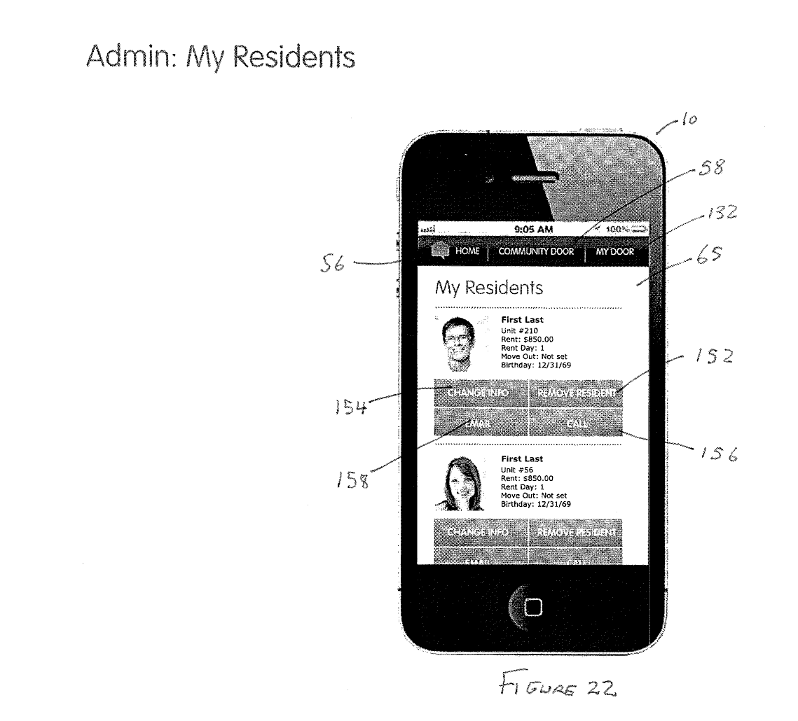

Further, in some embodiments, the home page 56 can include a message center page 92. As shown in FIG. 21, the message center page 92 can comprise a display of messages that have been sent to and/or from the user and/or administrator's account. For example, as shown in FIG. 21, the message center page 92 can include information suitable for identification of the sender (e.g. the photo image of the sender as shown in FIG. 21), or alternatively a name or other personal identifier, or a combination of one or more personal identifiers. As shown in FIG. 21, the message center page 92 can also comprise a send new message tab 104. Any user can select the send new message tab 104 to draft and send a message to the administrator and/or other users.

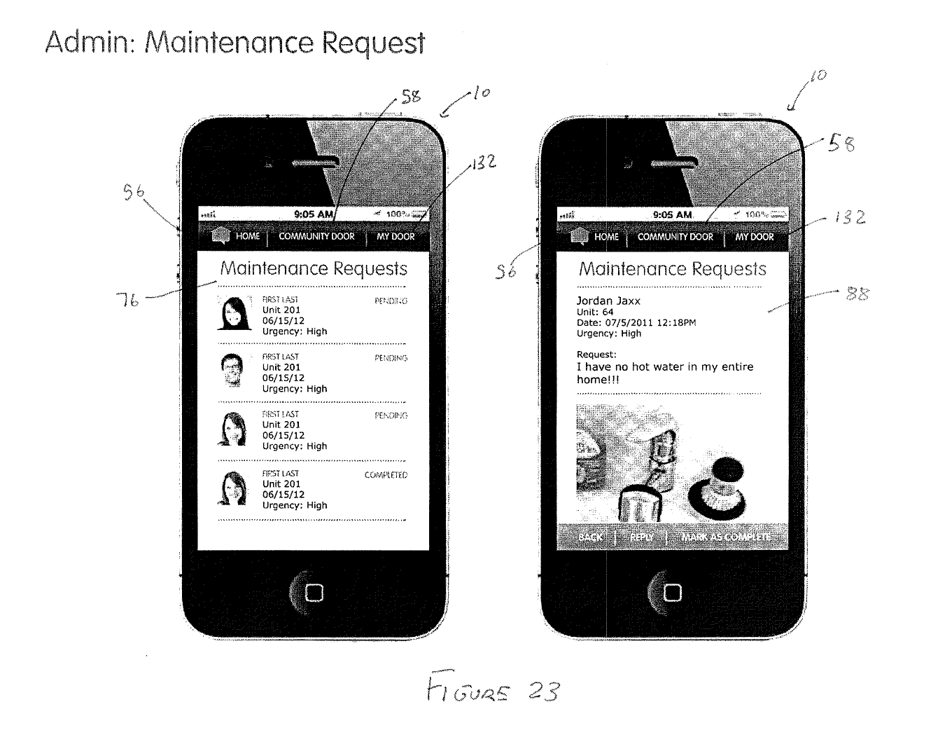

In some other embodiments, the home page 56 can also include a members page 65 (e.g., labeled as “My Residents” in FIG. 22). In some embodiments, the members page 65 can comprise relevant information about each member of the predetermined organization that is a part of the system 10. For example, as shown in FIG. 22, the predetermined organization can comprise a residential building and the members page 65 can comprise information regarding in which unit each resident resides, rent payments associated with each resident, phone numbers, and any other information that an administrator could deem relevant. Moreover, in some embodiments, the members page 65 can comprise icons to enable changing the status of a resident, or contacting the resident. For example, as shown in FIG. 22, in one embodiment the members page 65 can include various actions including, but not limited to remove resident 152, change info 154, where the personal or other member information can be modified, or alternatively in some embodiments, other methods to communicate with one or more of the members of the predetermined organization may be presented to the user, for example as shown in FIG. 22, with the email 158, or call 156 functions.

As previously mentioned, some embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way. It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method for social networking comprising:
establishing a group from a plurality of members of a predetermined organization, and storing in memory at least a single piece of personal information about the member;
associating at least some of the plurality of members with at least one subgroup based on the personal information submitted;
associating each of the plurality members with each of a personal communication board and a community communication board;

2. A method of claim 1, and further comprising:
receiving a plurality of communications created by at least a portion of the members;
displaying at least a portion of the plurality of communications created by at least a portion of the members on at least one of the personal communication board and the community communication board; and
automatically generating and displaying at least one advertising message on at least one of the personal communication board and the community communication board so that the advertising message comprises a substantially similar appearance to the plurality of communications created by at least a portion of the members.

3. A method of claim 2 and further comprising transmitting communications using a communication device.

4. A method of claim 3 where in the communication device includes at least one of a computer server, a personal desktop computer, a navigation system, a television, a DVD player, a refrigerator, and a multimedia system.

5. The system of claim 3 wherein the communication device includes at least one of a laptop computer, a tablet computer, personal-digital assistant, a wireless wrist-watch, a navigation system, a mobile phone and a smart phone.

6. The method of claim 4 or claim 5, wherein the plurality of members of a predetermined organization comprise residents of an apartment building.

7. The method of claim 4 or claim 5 and further comprising displaying a home page.

8. The method of claim 4 or claim 5, wherein the home page comprises at least one of the personal communication board, a listing of at least a portion of the members, and a listing of merchants.

9. The method of claim 4 or claim 5 and further comprising receiving a maintenance request from at least one of the members.

10. The method of claim 4 or claim 5 and further comprising receiving a payment from at least one of the members.

11. The method of claim 10, wherein the payment comprises at least one of a rent payment, a lease payment, an HOA fee, and a mortgage payment.

12. The method of claim 4 or claim 5, wherein the plurality of members of a predetermined organization comprise one or more persons affiliated with at least one of a home owners' association, a business, a university, a college, a private club, and a dues-charging organization.

13. The method of claim 4 or claim 5 and further comprising displaying a chat dialogue box.

14. The method of claim 4 or claim 5 and further comprising sending a package notification message to at least one of the members.

15. The method of claim 4 or claim 5 and further comprising creating a user name and a password for each request received.

16. A system for social connectivity comprising:
at least one computer server having a processing unit and a database, the at least one computer server connected to a network and configured to:
establish a social network from a plurality of members of a predetermined organization and;
associate each of the plurality of members with each of a personal communication board and a community communication board;

17. A system of claim 16, and further comprising a network configured to:
receive a plurality of communications created by at least a portion of the members;
display at least a portion of the plurality of communications created by at least a portion of the members on at least one of the personal communication board and the community communication board; and
automatically generate and display at least one advertising message on at least one of the personal communication board and the community communication board so that the advertising message comprises a substantially similar appearance to the plurality of communications created by at least a portion of the members.

18. The system of claim 17 wherein the computer server is further configured to receive at least one personal interest from at least a portion of the plurality of members and associate at least some of the plurality of members with at least one group based on the submitted personal interests.

19. The system of claim 18 and further comprising a communication device.

20. The system of claim 19 wherein the communication device includes at least one of a computer server, a personal desktop computer, a television, a DVD player, a refrigerator, a set-top box, and a multimedia system.

21. The system of claim 19 wherein the system is further configured for generating and presenting mobile content.

22. The system of claim 21 wherein the communication device comprises a mobile communication device.

23. The system of claim 22 wherein the mobile communication device includes at least one of a laptop computer, a tablet computer, personal-digital assistant, a wireless wrist-watch, a personal navigation system, a mobile phone and a smart
